(19) United States
(12) Patent Application Publication
(10) Pub. No.: US 2026/0215988 A1
(43) Pub. Date: Jul. 30, 2026

(54) TREATING HIP DISCOMFORT EXPERIENCED WHILE LYING ON SIDE

(71) Applicant: Lawrence P. Trapani, Manlius, NY (US)

(72) Inventor: Lawrence P. Trapani, Manlius, NY (US)

(21) Appl. No.: 19/037,222

(22) Filed: Jan. 26, 2025

(51) Int. Cl. A61G 13/12

(52) U.S. Cl. CPC A61G 13/123

(57) ABSTRACT

A method of treating hip discomfort experienced by a person (40) while lying on a side in which a hip (42) of the person (40) contacts a resting surface (RS). The discomfort is in an area of discomfort (46) within the hip (42). Method steps include: (a) using an elongated, handheld pad (20) proportioned for manual positioning about the hip (42); and (b) manually positioning the pad (20) about the hip (42) and substantially away from the area of discomfort (46) while the person (40) is lying in the side position, such that the pad (20) is placed in an operative position substantially between the hip (42) and resting surface (RS).

### BACKGROUND OF THE INVENTION

### Field of Invention

The present invention relates generally to the treatment of hip discomfort, and more particularly to a method, and a pad used in the method, of treating hip discomfort experienced by a person lying down in a side position.

### Background Art

For different reasons, some people prefer lying on their side for rest or sleep. However, sleeping or resting in this position may become difficult if the person resting or sleeping is experiencing hip discomfort. Hip discomfort may result from an injury (e.g., from a fall), osteoarthritis, infection, irritation, inflammation, excessive or repetitive movements (overuse), excessive or prolonged pressure (e.g., sleeping on hard surfaces, sitting in a low chair, or crossing legs), bone spurs or calcification, greater trochanteric pain syndrome (GTPS), trochanteric bursitis, femoroacetabular impingement (FAI), iliotibial band syndrome (ITBS), tendinopathy of the gluteus medius and minimus muscles, stress fracture of the femur or femoral neck, and other causes. For some people, the prolonged practice of sleeping on the side may, alone, cause hip discomfort. Hip discomfort can disturb a person's sleep, especially if he or she is lying on the affected side. Ultimately, hip discomfort may deter one from his or her preferred side position for sleep or rest.

Some causes of hip discomfort (e.g., GTPS or trochanteric bursitis) produce discomfort at about the center of the hip area, such as at the greater trochanter. Other causes produce discomfort off-center, for example, certain injuries or tendinopathy of the gluteus medius or minimus muscles. Thus, any solution for treating hip discomfort while side sleeping (or resting) must address the different possible areas of hip discomfort (not just at the center).

One approach to treating hip discomfort is the use of a hip pad. There are pads that cover or encircle the hip area and are generally centered over the hip area (e.g., at the greater trochanter). Examples of such pads are disclosed in U.S. Pat. No. 7,484,250 to Chiang; U.S. Pat. App. Pub. 2008/0134403 to Minns; U.S. Pat. No. 6,859,948 to Melts; U.S. Pat. No. 6,195,809 to Garcia; U.S. Pat. No. 5,636,377 to Wiener; and U.S. Pat. No. 4,641,641 to Strock. These pads are mostly used for cushioning (or absorbing shock) from a trauma event such as impacts or falls. The Minns patent document does suggest a secondary use -protecting against pressure sores. If the pads of these patent documents were used to treat hip discomfort for side sleepers, they would suffer from the drawback that an encompassing pad may exacerbate the discomfort if part of the pad presses in against an area of discomfort. These pads are not selective for different areas of discomfort about the hip (e.g., off-center). Further, most of the pads are fixed in position by a surrounding garment or garment pocket, which may restrict optimum positioning of the pad or in-place adjustment of the pad.

U.S. Pat. No. 6,745,406 to Ruane discloses the use of an annular or donut-shaped pad, attached to a garment, for treating hip discomfort (see FIG. 2). Ruane appears to understand, at least in principle, that the position of the pad should be adjustable to avoid discomfort, but this is achieved by making the pad removably attachable by hook & loop fasteners to the garment. Ruane treats hip discomfort by centering the pad at the greater trochanter (spot 165 in FIG. 2 represents the greater trochanter). The donut-shaped pad purportedly avoids exacerbating discomfort at the greater trochanter because of its donut hole. Thus, Ruane makes two assumptions about treating hip discomfort: (1) the hip discomfort is localized at the center of the hip area; and (2) the pad must be attached to a garment (or secured to the body) in a fixed position before use. As mentioned above with respect to the first group of patents, an encompassing pad could exacerbate the area of discomfort if the area is not localized at the center. Moreover, pre-attachment of the pad makes it difficult if not impossible to manually position or adjust the position of the pad once lying in the side position.

The following patents disclose single-member cushions or pads used by individuals while lying down for purposes other than treating hip discomfort (e.g., treating the lower back): U.S. Pat. No. 9,078,528 to Ramdath; U.S. Pat. No. 5,675,850 to Schmitt; U.S. Pat. No. 5,544,377 to Gostine; U.S. Pat. No. 3,604,023 to Lynch; and U.S. Pat. No. 2,612,158 to Manley. The Ramdath patent shows a urethane foam cushion for relieving lower back pain (see FIGS. 1 & 7). The cushion is placed on a mattress and is used while lying in the supine position. The cushion has a rounded arc (FIGS. 1 & 7) to elevate the lumbar spine. The Schmitt patent shows a cylindrical cushion (called a “bolster”) used to treat lumbar (lower back) pain (FIGS. 1, 3 & 4). It has a polyurethane tubular outer shell, which serves to cushion the user and prevent discomfort. It is used on a hard surface (e.g., a floor—see FIG. 4) and in the supine position. The patent to Gostine shows a polyurethane cushion used to treat the sacroiliac joint and lumber spine (FIGS. 1 & 2). The cushion is used while the user is lying on her side and is placed transverse to her body length (FIGS. 1 & 13). The Lynch patent shows a Styrofoam member (10) with a tapered end (FIG. 3) transversely placed under a patient, at the top of (above) the iliac crest, while lying in a side position. Also shown is a wedge-shaped member (30) used to support the abdomen (FIGS. 2 & 6). The purpose of the Lynch members (10, 30) is to position the patient for radiography. The Manley patent shows a cushioned, rectangularly shaped, wooden block (FIGS. 1 & 2) to be placed beneath the lower back to treat the sacroiliac joint. It may also be used under the neck.

While many of the above-discussed patent documents have devoted their attention to treating the hip, there remains a long-felt but unsolved need to adequately address hip discomfort experienced while lying down in a side position. Until now, the problem has not been fully understood. For instance, it has not been understood that the area of discomfort is not always located or localized at the center of the hip; that the area of discomfort may be located off-center or may extend from the center to off-center in one or more directions. The present invention adequately addresses the problem of hip discomfort experienced while lying on one's side and delivers a workable solution.

The term “side position,” as used in the specification and claims, includes the lateral position (or “lateral side position” or “lateral recumbent position”) and positions between the lateral position and the prone position and between the lateral position and the supine position. For example, the Sims'position (or semi-prone position) is a position between lateral and prone positions; and the semi-supine position is a position between supine and lateral positions. All of these positions are included within the meaning of (and are considered) “a side position.”

### OBJECTS AND SUMMARY OF THE INVENTION

It is therefore an object of the present invention to overcome the problems and limitations of the prior art, and to fulfill a long-felt but unresolved need to treat hip discomfort.

It is another object of the present invention to provide a method of treating hip discomfort experienced while lying down in a side position.

It is a further object of the present invention to provide a suitably configured and dimensioned pad for treating hip discomfort experienced while lying down in a side position.

It is still another object of the present invention to provide a suitably configured and dimensioned pad to be manually positioned between a person's hip and a resting surface, while the person is lying on the resting surface in a side position.

It is still a further object of the present invention to provide a suitably configured and dimensioned pad whose operative position between the hip and resting surface can be manually adjusted while the person is lying on the resting surface in a side position.

These and other objects are attained in accordance with the present invention, wherein there is provided, in a first embodiment, a method of treating hip discomfort experienced by a person while lying down in a side position, in which a hip of the person contacts a resting surface. The hip discomfort is in an area of discomfort within the hip. The method comprises the steps of: (a) using an elongated, handheld pad proportioned for convenient manual positioning of the pad about the hip; and (b) manually positioning the pad about the hip and substantially away from the area of discomfort while the person is lying in the side position, such that the pad is placed in an operative position substantially between the hip and the resting surface. In a second embodiment, the method may further include the step of: (c) manually adjusting the operative position of the pad between the hip and the resting surface. One exemplary approach to performing step (c) is by applying a manual force on any portion of the pad. The pad has opposing ends, and another approach to performing step (c) is by grabbing one or both of the opposing ends and moving the pad. The pad further includes opposing broad sides each having a smooth, low friction surface area, and step (b) includes orienting the pad such that one broad side is in contact with the hip and the other broad side is in contact with the resting surface. It is preferred that the smooth, low friction surface area extend over the entire surface of each broad side, but the invention is not so limited.

In some embodiments of the present invention, the pad has a “straight-line length” (see FIGS. 2, 6 & 9) in a preferred range of about 10 inches to about 18 inches. In some embodiments of the present invention, the pad has a width (see FIGS. 4, 8 & 10) in a preferred range of about two inches to about four inches. In some embodiments of the present invention, the pad has a thickness (FIGS. 4, 8 & 10) in a preferred range of about one-half inch to about one inch.

In one specific approach of the method, the person has a body with a lateral axis and step (b) (above) includes orienting the pad such that the pad extends substantially transverse to the lateral axis. In another approach of the method, the person has a body with a lateral axis and step (b) includes orienting the pad such that the pad extends substantially parallel to the lateral axis.

In a further approach of the method, the hip of a person includes a greater trochanter and step (b) (above) includes positioning the pad substantially away from the greater trochanter. For example, the pad may be positioned substantially above or below the greater trochanter.

In a third embodiment of the present invention, there is a method of treating hip discomfort experienced by a person while lying down in a side position, in which a hip of the person contacts a resting surface. The hip discomfort is located in an area of discomfort within the hip. The method comprises the steps of: (a) using an elongated, handheld pad proportioned for convenient manual positioning of the pad about the hip; (b) manually positioning the pad in a first position about the hip while the person is lying in the side position, such that the first position is substantially between the hip and the resting surface; (c) sensing whether the first position of the pad causes relief from the hip discomfort; and (d) if relief is not sensed in step (c), then manually adjusting the position of the pad between the hip and the resting surface until relief is sensed. The term “relief,” as used in this specification and the claims, has its ordinary meaning from dictionary definitions, and is further defined to include: a removal of pain, distress, oppression, etc.; or a lightening, diminishing, lessening, easing, alleviation, or mitigation of pain, distress, oppression, etc.

In a modification to the third embodiment, step (c) (above) includes sensing whether the first position of the pad is substantially away from the area of discomfort; and, if it is determined that the first position of the pad is not substantially away from the area of discomfort, then step (d) (above) includes manually adjusting the position of the pad between the hip and the resting surface until the pad is substantially away from the area of discomfort.

The elongated, handheld pad has opposing ends, and, in one specific implementation of the third embodiment, the action of manually adjusting the position of the pad in step (d) (above) is performed by grabbing one or both of the opposing ends and moving the pad. In another specific implementation, the person has a body defined by a lateral axis and step (b) (above) includes orienting the pad such that the pad extends either substantially transverse to the lateral axis or substantially parallel to the lateral axis.

A particular embodiment of the elongated, handheld pad will now be described. The pad is for treating hip discomfort experienced by a person while lying down in a side position in which a hip of the person contacts a resting surface. The elongated, handheld pad is proportioned for convenient manual positioning of the pad in an operative position between the hip and the resting surface. The pad has opposing tapered ends to facilitate the grabbing of one or both of the ends. The pad further includes opposing broad sides. In the operative position, one of the broad sides is in contact with the hip and the other one of the broad sides is in contact with the resting surface.

In a preferred embodiment, each of the broad sides of the pad has a smooth, low friction surface area to facilitate manual positioning of the pad in the operative position between the hip and resting surface. The smooth, low friction surface area extends over at least a portion of each broad side; but, it is preferred that the smooth, low friction surface area extend over the entire surface of each broad side. The smooth, low friction surface of the pad may be realized by a smooth, low friction shell or skin encasing the pad, or more simply by adopting a smooth, low friction core material for the pad and dispensing with a shell or skin.

In some embodiments, the elongated handheld pad has a “straight-line length” in a preferred range of about 10 inches to about 18 inches. In some embodiments, the pad has a width in a preferred range of about two inches to about four inches. In some embodiments, the pad has a thickness in a preferred range of about one-half inch to about one inch.

### BRIEF DESCRIPTION OF THE DRAWING

Further objects of the present invention will become apparent from the following description of the preferred embodiments with reference to the accompanying drawing, in which:

FIG. 1 is a perspective view of a pad for treating hip discomfort, constructed in accordance with one embodiment of the present invention;

FIG. 2 is a side elevation view of the pad shown in FIG. 1;

FIG. 3 is an end elevation view of the pad shown in FIG. 1;

FIG. 4 is a cross-sectional view of the pad of FIG. 1, taken along line 4-4 in FIG. 2;

FIG. 5 is a perspective view of a pad for treating hip discomfort, constructed in accordance with another embodiment of the present invention;

FIG. 6 is a side elevation view of the pad shown in FIG. 5;

FIG. 7 is an end elevation view of the pad shown in FIG. 5;

FIG. 8 is a cross-sectional view of the pad of FIG. 5, taken along line 8-8 in FIG. 6;

FIG. 9 is a side elevation view of a pad for treating hip discomfort, constructed in accordance with a further embodiment of the present invention;

FIG. 10 is a cross-sectional view of the pad of FIG. 9, taken along line 10-10 in FIG. 9;

FIG. 11 is a top plan view of a conceptual representation of a person lying in a side position on a resting surface RS, and schematically depicting the person's body, lateral axis L, greater trochanter area T, area of discomfort (56) surrounding trochanter area T, and operative pad positions 1, 2, 3 & 4;

FIG. 12 is a side-to-rear elevation view of a conceptual representation of the anatomy of a hip, schematically depicting an ilium (including iliac crest and anterior superior iliac spine), gluteus maximus muscle, gluteus medius & minimus muscles, the greater trochanter, and operative pad positions 1, 2 & 3;

FIG. 13 is a bottom plan view (i.e., looking up through a resting surface RS) of a conceptual representation of a person lying in a side position on the resting surface RS, and schematically depicting the step of manually positioning or adjusting the pad of FIG. 5, while the pad is in-place between the person's hip and the resting surface;

FIG. 14 is a flow diagram outlining the steps of a method according to one embodiment of the present invention; and

FIG. 15 is a flow diagram outlining the steps of a method according to another embodiment of the present invention.

### DETAILED DESCRIPTION OF THE PREFERRED EMBODIMENT

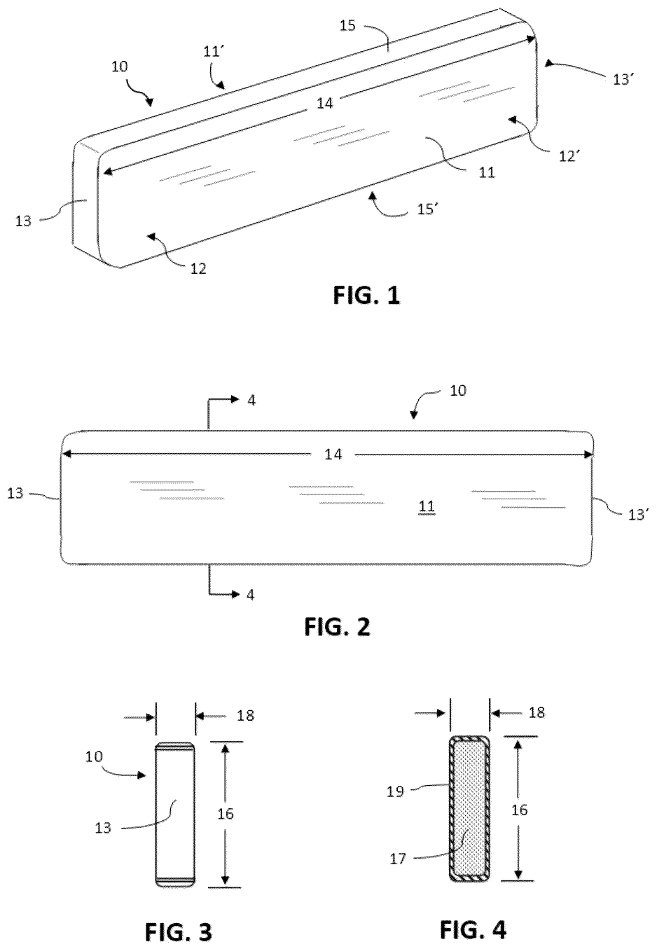

Referring to FIGS. 1-4, an elongated, handheld hip pad 10 is shown in various views. Pad 10 is an exemplary embodiment of a pad used in a method of the present invention to treat hip discomfort. Pad 10 treats hip discomfort experienced while a person is lying down in a side position, in which a hip of the person is in contact with a resting surface RS (see FIG. 11). Pad 10 has a generally rectangular prism shape, as shown in FIG. 1. Pad 10 has opposing broad sides 11, 11′, opposing ends 12, 12′, opposing end faces 13, 13′, a straight-line length 14 defined by end faces 13, 13′, opposing top and bottom sides 15, 15′, a width 16 (FIG. 3), and a thickness 18 (FIG. 3). Broad sides 11, 11′ are essentially defined by length 14 and width 16. Top and bottom sides 15, 15′ are essentially defined by length 14 and thickness 18. End faces 13, 13′ are essentially defined by width 16 and thickness 18. Sides 11, 11′, end faces 13, 13′, and top and bottom sides 15, 15′ are largely planar and rectangular in shape. Length 14, width 16, and thickness 18 are proportioned for convenient, manual positioning of pad 10 about the hip and in an operative position between the hip and a resting surface RS (see RS in FIG. 11). Length 14, width 16, and thickness 18 are also proportioned for convenient, manual (in-place) adjustment of the operative position. In a preferred range of embodiments, the proportions of the length, width and thickness of pad 10 are as follows: length 14 is in a range of about 10 inches to about 18 inches; width 16 is in a range of about two inches to about four inches; and thickness 18 is in a range of about one-half inch to about one inch. In one embodiment, length 14 is about 13 inches, width 16 is about 2.25 inches, and thickness 18 is about 0.75 inches.

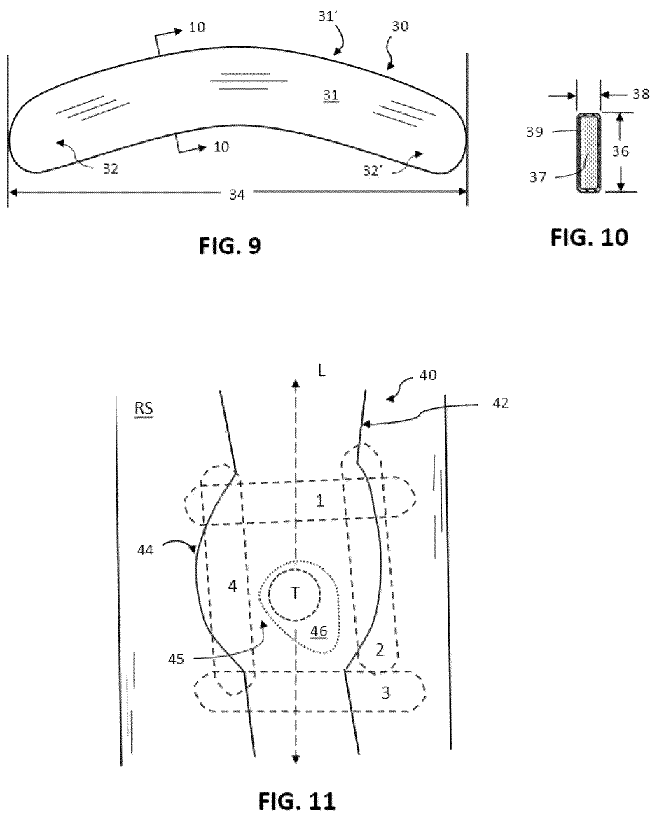

Opposing ends 12, 12′ (FIG. 1) are defined as those portions of pad 10 extending inward from end faces 13, 13′, respectively, by an amount sufficient to allow each portion (end) to be grabbed by a hand. A “straight-line length” (mentioned above) is a dimension of the pad, which represents the maximum straight-line extent of a pad. For a prism-shaped pad, the maximum straight-line length is the length. For a curved pad (see, e.g., FIG. 9), the straight-line length is a straight dimension (34) from one end of the pad to the other end (i.e., the maximum straight-line extent of the pad).

Manually positioning pad 10 (or adjusting its position) between the hip and resting surface can be accomplished by applying a manual force on any portion of the pad. In a preferred approach, one or both opposing ends 12, 12′ of pad 10 are grabbed with the hand(s) or fingers to move pad 10. The person can position or adjust the position of pad 10 (in-place) by grabbing one or both ends 12, 12′. Broad sides 11, 11′ each have a smooth, low friction surface area extending over at least a portion of the side. It is preferred that the entire surface area of each broad side 11, 11′ has a smooth, low friction surface. The smooth, low friction surfaces of broad sides 11, 11′ will facilitate manual positioning of the pad between the hip and the resting surface, as one side 11/11′ will be in contact with the hip and the other side 11/11′ will be in contact with the resting surface. Manual, in-place positioning and adjustment of pad 10 will be further described with reference to FIG. 13.

FIG. 4 shows a cross-sectional view of pad 10 taken along line 4-4 in FIG. 2. This view reveals the construction of pad 10. Pad 10 includes a solid foam core 17 made of, for example, Ethylene-Vinyl Acetate (EVA) foam (a closed-cell, flexible foam material) or Thermoplastic Elastomers (TPE) foam. Foam core 17 is encased by a smooth, low friction (e.g., slippery) plastic shell or skin 19, such as, for example, ultra-high molecular weight (UHMW) Polyethylene, reinforced Polyethlene sheet, Teflon film, Polyester, Nylon, or Rayon. Shell or skin 19 may not be needed if core 17 is sufficiently smooth and low friction to permit convenient manual positioning of pad 10 between the hip and resting surface. A smooth, low friction surface is a preferred characteristic for pad 10 to facilitate manual positioning of the pad, in-place, wedged between the hip and resting surface. The smooth, low friction surface can be accomplished either with a smooth and slippery skin 19 encasing core 17 (FIG. 4) or by choosing a smooth, low friction material for core 17 and eliminating skin 19.

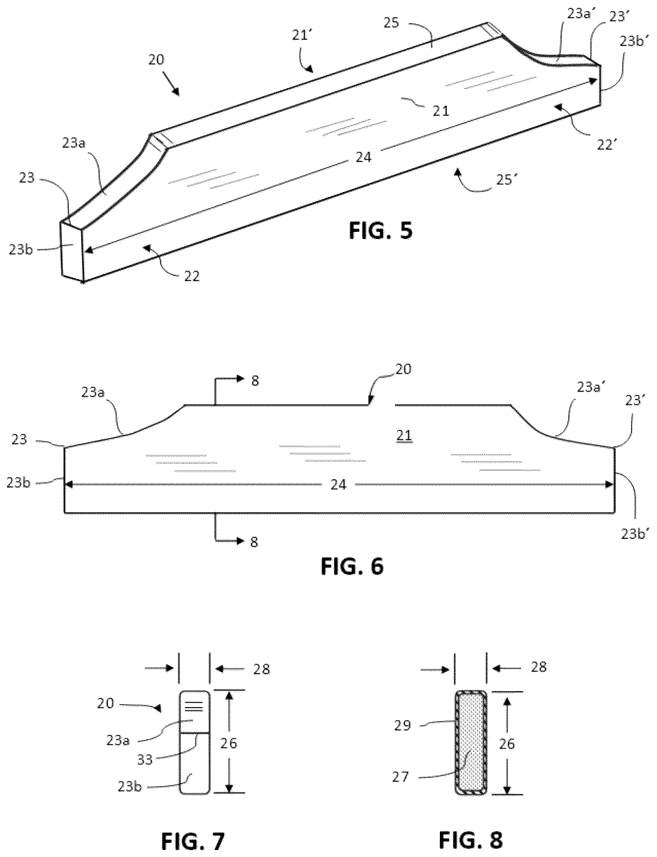

Referring now to FIGS. 5-8, an elongated, handheld hip pad 20 is shown in various views. Pad 20 is another exemplary embodiment of a pad used in a method of the present invention to treat hip discomfort. Pad 20 treats hip discomfort experienced while a person is lying down in a side position, in which a hip of the person is in contact with a resting surface RS (see FIG. 11). As shown in FIGS. 5 and 6, pad 20 has a generally rectangular prism shape, except for tapered ends. Pad 20 has opposing broad sides 21, 21′, opposing ends 22, 22′, opposing end faces 23, 23′, a straight-line length 24 defined by end faces 23, 23′, opposing top and bottom sides 25, 25′, a width 26 (see FIG. 7), and a thickness 28 (see FIG. 7). As shown in FIGS. 5 and 6, end face 23 has a sloped face portion 23a and a rectangular face portion 23b, and end face 23′ has a sloped face portion 23a′ and a rectangular face portion 23b′. In a variation of this embodiment, each end 22, 22′ is configured with two symmetric, opposing sloped face portions terminating at a central planar face portion. Length 24, width 26, and thickness 28 are proportioned for convenient, manual positioning of pad 20 about the hip and in an operative position between the hip and a resting surface RS (see RS in FIG. 11). Length 24, width 26, and thickness 28 are also proportioned for convenient, manual (in-place) adjustment of the operative position. In a preferred range of embodiments, the proportions of the length, width and thickness of pad 20 are as follows: length 24 is in a range of about 10 inches to about 18 inches; width 26 is in a range of about two inches to about four inches; and thickness 28 is in a range of about one-half inch to about one inch. In one embodiment, length 24 is about 13 inches, width 26 is about 2.25 inches, and thickness 28 is about 0.75 inches.

Opposing ends 22, 22′ (FIG. 5) are defined as those portions of pad 20 extending inward from end faces 23, 23′, respectively, by an amount sufficient to allow each portion (each end) to be grabbed by a hand. A “straight-line length” (mentioned above) is a dimension of the pad, which represents the maximum straight-line extent of a pad. The maximum extent of pad 20 is defined by end faces 23b, 23b′, which, in turn, define straight-line length 24.

Manually positioning pad 20 (or adjusting its position) between the hip and resting surface can be accomplished by applying a manual force on any portion of the pad. In a preferred approach, one or both opposing ends 22, 22′ of pad 20 are grabbed with the hand(s) or fingers to move pad 20. Ends 22, 22′ are tapered to facilitate the grabbing of ends 22, 22′ with the person's hands or just the fingers (see FIG. 13). The person can position or adjust the position of pad 20 (in-place) by grabbing one or both tapered opposing ends 22, 22′. Broad sides 21, 21′ each have a smooth, low friction surface area extending over at least a portion of the side. It is preferred that the entire surface area of each broad side 21, 21′ has a smooth, low friction surface. The smooth, low friction surfaces of broad sides 21, 21′ will facilitate manual positioning of the pad between the hip and the resting surface, as one side 21/21′ will be in contact with the hip and the other side 21/21′ will be in contact with the resting surface. Manual, in-place adjustment of pad 20 will be further described below with reference to FIG. 13.

FIG. 8 shows a cross-sectional view of pad 20 taken along line 8-8 in FIG. 6. This view reveals the construction of pad 20. Pad 20 includes a solid foam core 27 made of, for example, Ethylene-Vinyl Acetate (EVA) foam (a closed-cell, flexible foam material) or Thermoplastic Elastomers (TPE) foam. Foam core 27 is encased by a smooth, low friction (e.g., slippery) plastic shell or skin 29, such as, for example, ultra-high molecular weight (UHMW) Polyethylene, reinforced Polyethlene sheet, Teflon film, Polyester, Nylon, or Rayon. Shell or skin 29 may not be needed if core 27 is sufficiently smooth and low friction to permit convenient manual positioning of pad 20 between the hip and resting surface. A smooth, low friction surface is a preferred characteristic for pad 20 to facilitate manual positioning of the pad, in-place, wedged between the hip and resting surface. The smooth, low friction surface can be accomplished either with a smooth and slippery skin 29 encasing core 27 (FIG. 8) or by choosing a smooth, low friction material for core 27 and eliminating skin 29.

Referring now to FIG. 9, there is shown a side elevation view of an elongated, handheld hip pad 30. Pad 30 is another exemplary embodiment of a pad used in a method of the present invention to treat hip discomfort. Pad 30 treats hip discomfort experienced while a person is lying down in a side position, in which a hip of the person is in contact with a resting surface RS (see FIG. 11). As shown in FIG. 9, pad 30 has an overall arched or curved shape, otherwise it is similarly constructed like pad 10. Pad 30 has opposing broad sides 31, 31′, opposing ends 32, 32′, a straight-line length 34, a width 36 (see FIG. 10), and a thickness 38 (see FIG. 10). Pad 30 also has arched top and bottom sides and rounded end faces, as shown. Length 34, width 36, and thickness 38 are proportioned for convenient, manual positioning of pad 30 about the hip and in an operative position between the hip and a resting surface RS (see RS in FIG. 11). Length 34, width 36, and thickness 38 are also proportioned for convenient, manual (in-place) adjustment of the operative position. In a preferred range of embodiments, the proportions of the length, width and thickness of pad 30 are as follows: length 34 is in a range of about 10 inches to about 18 inches; width 36 is in a range of about two inches to about four inches; and thickness 38 is in a range of about one-half inch to about one inch. In one embodiment, length 34 is about 13 inches, width 36 is about 2.25 inches, and thickness 38 is about 0.75 inches.

Manually positioning pad 30 (or adjusting its position) between the hip and resting surface can be accomplished by applying a manual force on any portion of the pad. In a preferred approach, pad 30 is positioned (or its position is adjusted) by grabbing one or both opposing ends 32, 32′ with the hand(s) or fingers to move pad 30. Broad sides 31, 31′ each have a smooth, low friction surface area extending over at least a portion of the side. It is preferred that the entire surface area of each broad side 31, 31′ has a smooth, low friction surface. The smooth, low friction surfaces of broad sides 31, 31′ will facilitate manual positioning of the pad between the hip and the resting surface, as one side 31/31′ will be in contact with the hip and the other side 31/31′ will be in contact with the resting surface. Manual, in-place adjustment of pad 30 will be further described below in reference to FIG. 13.

FIG. 10 shows a cross-sectional view of pad 30 taken along line 10-10 in FIG. 9. This view reveals the construction of pad 30. Pad 30 includes a solid foam core 37 made of, for example, Ethylene-Vinyl Acetate (EVA) foam (a closed-cell, flexible foam material) or Thermoplastic Elastomers (TPE) foam. Foam core 37 is encased by a smooth, low friction (e.g., slippery) plastic shell or skin 39, such as, for example, ultra-high molecular weight (UHMW) Polyethylene, reinforced Polyethlene sheet, Teflon film, Polyester, Nylon, or Rayon. Shell or skin 39 may not be needed if core 37 is sufficiently smooth and low friction to permit convenient manual positioning of pad 30 between the hip and resting surface. A smooth, low friction surface is a preferred characteristic for pad 30 to facilitate manual positioning of the pad, in-place, wedged between the hip and resting surface. The smooth, low friction surface can be accomplished either with a smooth and slippery skin 39 encasing core 37 (FIG. 10) or by choosing a smooth, low friction material for core 37 and eliminating skin 39.

Referring now to FIG. 11, there is shown a top plan view of a person 40 lying in a side position on a resting surface RS (FIG. 11 is a conceptual representation). FIG. 11 schematically depicts a body 42 having a body length which extends along a lateral axis L. Body 42 includers a left hip 44 (remote) and a right hip 45. The greater trochanter of hip 44 is conceptually indicated by an area T. Again, hip 44 is the remote hip in FIG. 11 (i.e., in contact with resting surface RS). FIG. 11 also depicts possible operative positions 1, 2, 3, & 4 of an elongated, handheld hip pad of the present invention (shown in phantom lines). The operative positions 1, 2, 3, & 4 are substantially between hip 44 and resting surface RS. In FIG. 11, hip 44 contains an area of discomfort 46, which surrounds trochanter area T and extends out to a point off-center from trochanter area T (see FIG. 11). As shown in FIG. 11, the pad of the present invention is positioned about hip 44, in all operative positions 1, 2, 3, & 4. Operative positions 1, 2, 3, & 4 are located substantially at the perimeter of hip 44 and away from area of discomfort 46 and trochanter area T. The pad of the present invention is manually positioned in operative positions 1, 2, 3, or 4 while person 40 is lying down in a side position on resting surface RS. Resting surface RS can be, for example, a mattress, couch, mat, pad, floor, the ground, or other surface for resting body 42.

Again referring to FIG. 11. Operative position 1 is where the pad (e.g., pad 10, 20 or 30) is positioned and oriented substantially transverse to lateral axis L (i.e., the straight-line length of the pad is substantially transverse to lateral axis L); and, in operative position 1, the pad is above the greater trochanter area T. Operative position 2 is where the pad (e.g., pad 10, 20 or 30) is positioned and oriented substantially parallel to lateral axis L (i.e., the straight-line length of the pad is substantially parallel to lateral axis L); and, in operative position 2, the pad is at the front of hip 44. Operative position 3 is where pad (e.g., pad 10, 20 or 30) is positioned and oriented substantially transverse to lateral axis L (i.e., the straight-line length of the pad is substantially transverse to lateral axis L); and, in operative position 3, the pad is below the greater trochanter area T. Operative position 4 is where the pad (e.g., pad 10, 20 or 30) is positioned and oriented substantially parallel to lateral axis L (i.e., the straight-line length of the pad is substantially parallel to lateral axis L); and, in operative position 4, the pad is at the rear of hip 44.

The present invention is not limited to positioning the hip pad in operative positions 1, 2, 3 & 4. Any number of operative positions can be established based on the area of discomfort in the hip and the preferred step of positioning the pad away from the area of discomfort. For example, the straight-line length of the pad can be oriented at any angle relative to lateral axis L (e.g., at 30 degrees, 45 degrees, 60 degrees, 90 degrees, 120 degrees, etc.). In another example, the pad can be oriented tangentially about the perimeter of the hip, at any point about the perimeter. Keep in mind that the area of discomfort is not always located or localized at the center of the hip (e.g., trochanter area T); it may extend from the center in one or more directions (see FIG. 11; discomfort area 46), or it may be located outside of the center.

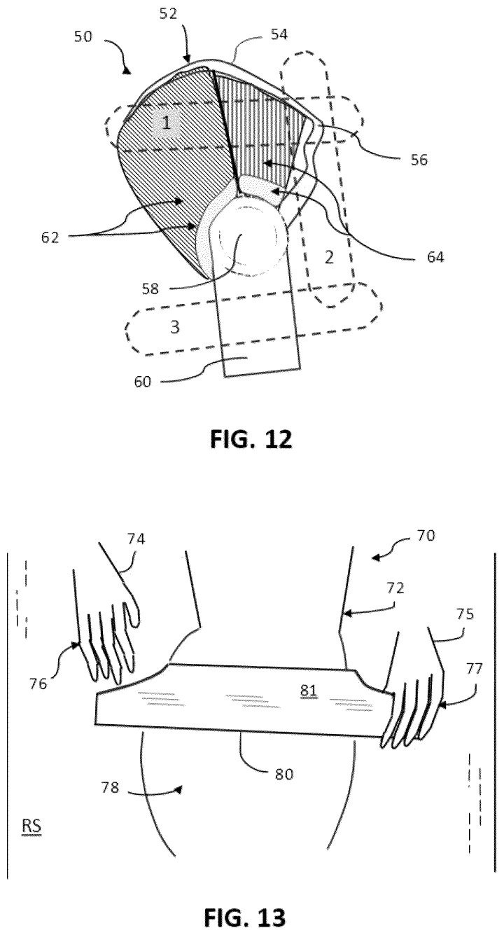

Referring now to FIG. 12, there is shown an elevation view of a conceptual representation of the anatomy of a human hip 50 (or hip 44 of person 40). FIG. 12 schematically depicts an ilium 52 having an iliac crest 54 and an anterior superior iliac spine 56. Hip 50 further includes a greater trochanter 58 and a femur 60. The muscle and tendon structure of hip 50 includes a Gluteus Maximus muscle and tendon 62 and Gluteus Medius and Minimus muscles and tendons 64. The anatomy of hip 50 is shown to help illustrate the relative placement (about the hip) of the hip pad of the present invention. In FIG. 12, operative position 1 has the pad oriented transversely across illum 52 at about iliac crest 54 or somewhere between iliac crest 54 and greater trochanter 58. One approach to locating operative position 1 is to find iliac spine 56 (located, side-to-anterior) and center the pad over iliac spine 56 as shown in FIG. 12. Operative position 2 is oriented substantially parallel to the body and, in one example, positioned over iliac spine 56 and away from trochanter 58. Operative position 3 generally transverses femur 60 and is positioned away from trochanter 58. A goal is to have an appropriately proportioned hip pad that allows manual positioning (and adjustment) of the pad about the hip and away from an area of discomfort.

Referring to FIG. 13, there is shown a bottom plan view (i.e., looking up through a resting surface RS) of a conceptual representation of a person lying in a side position on a resting surface RS. FIG. 13 schematically depicts the step of manually positioning or adjusting the position of a hip pad, while the pad is in-place between the person's hip and resting surface RS. In FIG. 13, a person 70 has a body 72 and a pair of hands 74, 75. Hands 74 and 75 have a set of fingers 76 and 77, respectively. Body 72 includes a hip 78. In FIG. 13, person 70 is lying in a side position, where hip 78 is in contact with (or resting on) resting surface RS (again, the view in FIG. 13 is looking up through resting surface RS). Wedged between hip 78 and resting surface RS is a hip pad 80 constructed in accordance with the second embodiment of the present invention (see FIGS. 5-8). Pad 80 is positioned substantially in operative position 1. In this embodiment, the straight-line length of pad 80 is sufficient for the tapered ends of pad 80 to extend at least partially beyond the sides (front and back), respectively, of hip 78. This arrangement allows hands 74, 75 (or just fingers 76, 77) to grab the tapered ends of pad 80, respectively, and move pad 80.

One or both ends of pad 80 may be grabbed to manually position (or adjust the position of) pad 80, while pad 80 is wedged in-place between hip 78 and resting surface RS. Pad 80 can be easily and conveniently moved, while wedged in-place, simply by grabbing one or both tapered ends of pad 80 with one or both hands 74, 75 (or just fingers 76, 77). The tapered ends of this embodiment facilitate the grabbing of the ends. In many cases, grabbing one end of pad 80 with one hand or one set of fingers is sufficient to position or adjust the position of pad 80. If person 70 senses an area of discomfort in hip 78 resulting from the position of pad 80, he or she can make an adjustment of the position by grabbing either or both ends of pad 80 and moving pad 80 away from the area of discomfort. As in FIGS. 5-8, pad 80 has opposing broad sides 81 (one side is hidden in FIG. 13). Each broad side 81 has a smooth, low friction surface area, which further facilitates the positioning of pad 80 between hip 78 and resting surface RS.

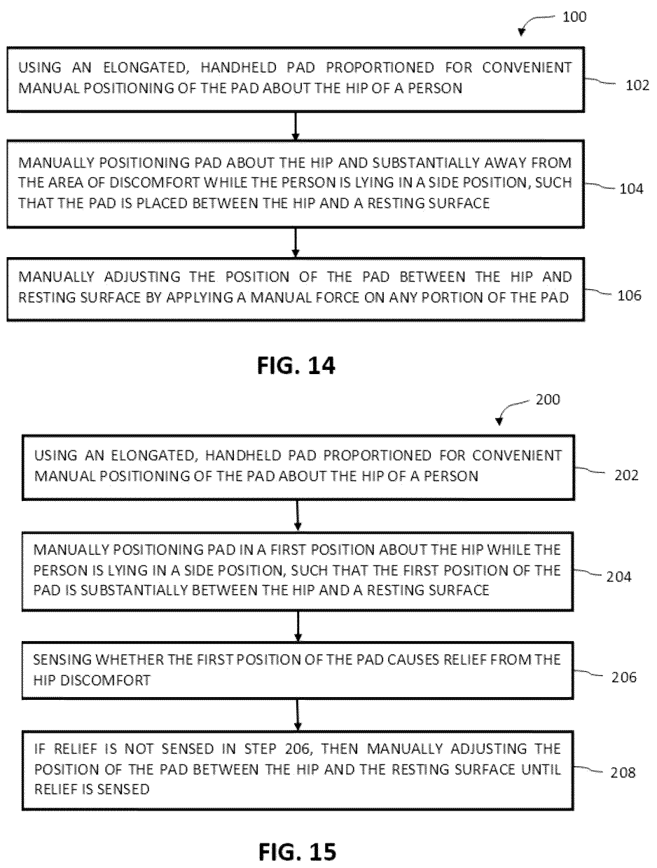

Referring now to FIG. 14, a flow diagram is shown outlining the steps of a method according to one embodiment of the present invention. A method 100 concerns the treatment of hip discomfort experienced by a person while lying down in a side position, in which a hip of the person is in contact with a resting surface. The discomfort is located in an area of discomfort within the hip. Method 100 comprises steps 102, 104 and 106. Step 102 includes using an elongated, handheld pad (e.g., see FIGS. 1, 5, and 9) proportioned for convenient manual positioning of the pad about the hip of the person. Step 104 includes manually positioning the pad about the hip and substantially away from the area of discomfort while the person is lying in the side position. In such instance, the pad is placed in an operative position substantially between the hip and the resting surface. Lastly, step 106 includes manually adjusting the operative position of the pad between the hip and the resting surface. Step 106 can be performed by applying a manual force on any portion of the pad. In a preferred approach, one or both opposing ends of the elongated pad are grabbed with the hand(s) or fingers to move the pad. In one particular embodiment, the performance of step 106 is conditioned upon whether an adjustment of the pad position is necessary after performing step 104.

Referring to FIG. 15, a flow diagram is shown outlining the steps of a method according to another embodiment of the present invention. A method 200 concerns the treatment of hip discomfort experienced by a person while lying down in a side position, in which a hip of the person contacts a resting surface. The discomfort is located in an area of discomfort within the hip. Method 200 comprises steps 202, 204, 206, and 208. Step 202 includes using an elongated, handheld pad proportioned for convenient manual positioning of the pad about the hip of the person. Step 204 includes manually positioning the pad in a first position about the hip while the person is lying in the side position. In such case, the first position of the pad is substantially between the hip and the resting surface. Step 206 includes sensing whether the first position of the pad causes relief from the hip discomfort. This is typically done by the person using his or her ability to sense or feel discomfort (e.g., pain). Step 208 is a conditional step. In step 208, if relief is not sensed in step 206, then the position of the pad is manually adjusted between the hip and the resting surface until relief is sensed.

In a variation of method 200, step 206 may include sensing whether the first position of the pad is substantially away from the area of discomfort; and, if it is not, then step 208 is performed by manually adjusting the position of the pad (between the hip and the resting surface) until the pad is substantially away from the area of discomfort. Again, the sensing is typically done by the person using his or her ability to sense or feel discomfort (e.g., pain).

While various embodiments of the invention have been particularly described in the specification and illustrated in the drawing, the invention is not so limited. Many modifications, equivalents and adaptations of the invention will become apparent to those skilled in the art without departing from the spirit and scope of the invention, as defined in the appended claims.

What I claim is:

1. A method of treating hip discomfort experienced by a person while lying down in a side position in which a hip of the person contacts a resting surface, the hip discomfort being located in an area of discomfort within the hip, the method comprising the steps of:
(a) using an elongated, handheld pad proportioned for convenient manual positioning of the pad about the hip; and
(b) manually positioning the pad about the hip and substantially away from the area of discomfort while the person is lying in the side position, such that the pad is placed in an operative position substantially between the hip and the resting surface.

2. The method of claim 1, further comprising the step of:
(c) manually adjusting the operative position of the pad between the hip and the resting surface.

3. The method of claim 2, wherein the elongated pad has opposing ends, and wherein step (c) is performed by grabbing one or both of the opposing ends and moving the pad.

4. The method of claim 1, wherein the person has a body defined by a lateral axis, and wherein step (b) includes orienting the pad such the pad extends substantially transverse to the lateral axis.

5. The method of claim 1, wherein the person has a body defined by a lateral axis, and wherein step (b) includes orienting the pad such that the pad extends substantially parallel to the lateral axis.

6. The method of claim 1, wherein the hip of the person includes a greater trochanter, and wherein step (b) includes positioning the pad substantially away from the greater trochanter.

7. The method of claim 1, wherein the pad further includes opposing broad sides each having a smooth, low friction surface area; and wherein step (b) includes orienting the pad such that one of the broad sides is in contact with the hip and the other one of the broad sides is in contact with the resting surface.

8. The method of claim 1, wherein the pad is defined by a straight-line length, the straight-line length being in a range of about 10 inches to about 18 inches.

9. The method of claim 1, wherein the pad is defined by a width, the width being in a range of about two inches to about four inches.

10. The method of claim 1, wherein the pad is defined by a thickness, the thickness being in a range of about one-half inch to about one inch.

11. A method of treating hip discomfort experienced by a person while lying down in a side position in which a hip of the person contacts a resting surface, the hip discomfort being located in an area of discomfort within the hip, the method comprising the steps of:
(a) using an elongated, handheld pad proportioned for convenient manual positioning of the pad about the hip;
(b) manually positioning the pad in a first position about the hip while the person is lying in the side position, such that the first position is substantially between the hip and the resting surface;
(c) sensing whether the first position of the pad causes relief from the hip discomfort; and
(d) if relief is not sensed in step (c), then manually adjusting the position of the pad between the hip and the resting surface until relief is sensed.

12. The method of claim 11, wherein step (c) includes sensing whether the first position of the pad is substantially away from the area of discomfort; and, wherein if it is determined that the first position of the pad is not substantially away from the area of discomfort, then step (d) includes manually adjusting the position of the pad between the hip and the resting surface until the pad is substantially away from the area of discomfort.

13. The method of claim 11, wherein the elongated pad has opposing ends, and wherein manually adjusting the position of the pad in step (d) is performed by grabbing one or both of the opposing ends and moving the pad.

14. The method of claim 11, wherein the person has a body defined by a lateral axis, and wherein step (b) includes orienting the pad such that the pad extends substantially transverse to the lateral axis.

15. The method of claim 11, wherein the person has a body defined by a lateral axis, and wherein step (b) includes orienting the pad such that the pad extends substantially parallel to the lateral axis.

16. An elongated, handheld pad for treating hip discomfort experienced by a person while lying down in a side position in which a hip of the person contacts a resting surface, said elongated, handheld pad being proportioned for convenient manual positioning of said pad in an operative position between the hip and the resting surface, said pad having opposing tapered ends to facilitate the grabbing of one or both of the ends.

17. The pad of claim 16, wherein said pad is defined by a straight-line length, the straight-line length being in a range of about 10 inches to about 18 inches.

18. The pad of claim 16, wherein said pad is defined by a width, the width being in a range of about two inches to about four inches.

19. The pad of claim 16, wherein said pad is defined by a thickness, the thickness being in a range of about one-half inch to about one inch.

20. The pad of claim 16, further including opposing broad sides, whereby, in the operative position, one of the broad sides is in contact with the hip and the other one of the broad sides is in contact with the resting surface,
each of the broad sides having a smooth, low friction surface area to facilitate the manual positioning of said pad in the operative position.
